(19) United States
(12) Patent Application Publication
(10) Pub. No.: US 2019/0320641 A1
(43) Pub. Date: Oct. 24, 2019

(54) WEED INACTIVATION DEVICE

(71) Applicant: Zasso Group AG, Baar (CH)

(72) Inventors: Sérgio Alexandre RONA, Sao Paulo (BR); Bruno VALVERDE, Campinas-SP (BR); Diego Teruo MENDES DE SOUZA, Campinas-SP (BR); Sergio de Andrade COUTINHO FILHO, Indaiatuba (BR)

(73) Assignee: Zasso Group AG, Baar (CH)

(21) Appl. No.: 16/257,241

(22) Filed: Jan. 25, 2019

(30) Foreign Application Priority Data
Apr. 19, 2018 (DE) 10 2018 003 199.4

(51) Int. Cl. A01M 21/04

(52) U.S. Cl. CPC A01M 21/046

(57) ABSTRACT

A weed inactivation device has at least two electrodes, whereby at least one electrode is directed to the weed. The weed activation device is used as a physical herbicide apparatus. A DC or AC power supply of any number of phases generates a voltage. This voltage is fed to an inverter that increases frequency. The current with increased frequency is fed to a harmonic filter. The harmonic filter may feed a high frequency transformer that further increases the voltage input for the voltage multiplier. The output of the previous components is fed to a voltage multiplier, such as a voltage multiplier of the Cockroft-Walton type or a full wave Cockroft-Walton type. The voltage multiplier provides different voltage levels depending on its load, so for a variable load it makes an auto-adjustable power control without any additional circuitry, processor or controller necessity.

### CROSS REFERENCE TO RELATED APPLICATIONS

Applicant claims priority under 35 U.S.C. § 119 of German Application No. 10 2018 003 199.4 filed Apr. 19, 2018, the disclosure of which is incorporated by reference.

### BACKGROUND OF THE INVENTION

### 1. Field of the Invention

The invention relates to weed inactivation device, comprising at least two electrodes, whereby the at least one electrode is directed to the weed. The weed activation device is used as a physical herbicide apparatus.

### 2. Description of the Related Art

A weed activation device of the generic type has been disclosed in the yet unpublished international patent application PCT/IB2017001456. According to PCT/IB2017001456 a high voltage is created by the utilization of high voltage transformers. The high-voltage in the range of 1 kV to 20 kV is applied to an electrode which contacts the weed to be controlled or which is brought close to the weed. This physical herbicide has the great advantage of not utilizing chemical herbicides, which may proliferate into the food chain up to humans.

### SUMMARY OF THE INVENTION

It is an object of the current invention is to provide for a circuitry, which allows use of small, cheap and available electronic components to comprise a high power-factor converter that controls for power without the need of software or other larger components required in previous technological generations. This particular converter is composed of at least the following components: An inverter, an inductive and or capacitive harmonic filter, a capacitive voltage multiplier composed of diodes and capacitors.

Therefore, a weed inactivation device is proposed, comprising at least two electrodes, whereby the at least one electrode is directed to the weed and is supplied with electrical energy by at least one electrical power supply. The at least one electrical power supply could as an example comprise an AC current supply having a frequency in the range of 30 Hz to 90 Hz, preferably in the range of 50 Hz to 60 Hz, and whereby the AC current is rectified by a full-wave rectifier, creating pulsed DC current doubling the AC frequency.

According to the invention a weed activation device is proposed, which is operated with any power supply available.

The power supply is fed to an inverter such as a full or half bridge inverter to create a high frequency current of different frequency than the input current. This current from the inverter can be conducted to a high frequency transformer, whereas the output voltage of the high frequency transformer is in the range of 1 kV to 12 kV and then the output current is the multiplied by a voltage multiplier such as a hexuplicator of the Cockroft-Walton type. Alternatively, the output from the inverter can be fed directly to the voltage multiplier. The multiplier makes it unnecessary to utilize higher voltage transformers, which out up a high demand on electrical insulation of the coiling wires and the connection wiring. The output of the hexuplicator is then conducted to the electrodes for electrical weeding.

A different topology for the electronic converter proposed before can be made for monophasic circuits, as shown in FIG. 1. The invasive plant may be represented as a variable resistive load from the electric/electronic point of view, as already justified before.

The topology elements are listed below:
a power source, such as the power grid or a generator;
a rectifier or rectification bridge if the power source is AC;
an inverter such as a half-bridge or full-bridge inverter;
a capacitive and/or inductive harmonic filter;
a high frequency transformer;
a capacitive voltage multiplier.

For example, with the use of a voltage doubler as the voltage multiplier fed by the transformer's secondary, the isolation issues for the transformer's high voltage operation is reduced, as well as the number of turns necessary to achieve the desired voltage levels, facilitating the transformer's construction and reducing its size, weight and volume, that were already reduced for the high frequency operation.

Adjusting the inductor and/or inductive/capacitive filter value so the inverter's IGBT can work with resonant switching reduces its conduction losses and increases the converter's efficiency. The IGBT's resonance frequency is tuned as the resonance between the external inductor and the total capacitance reflected to the transformer's primary or directly to the voltage multiplier, considering the effects of the variable load and the voltage multiplier.

### BRIEF DESCRIPTION OF THE DRAWINGS

The invention will be explained with reference to the drawings. It is to be understood that the drawings are for reference only and are not to be considered limiting of the invention. In the drawings, wherein similar reference numerals constitute similar elements:

FIG. 1 shows a diagram of the circuit providing the current for the weeding device;

FIG. 2 shows an alternative embodiment of the circuit;

FIG. 3 shows another alternative embodiment of the circuit;

FIG. 4 shows yet another alternative embodiment of the circuit, and

FIG. 5 shows yet another alternative embodiment of the circuit.

### DETAILED DESCRIPTION OF THE DRAWINGS

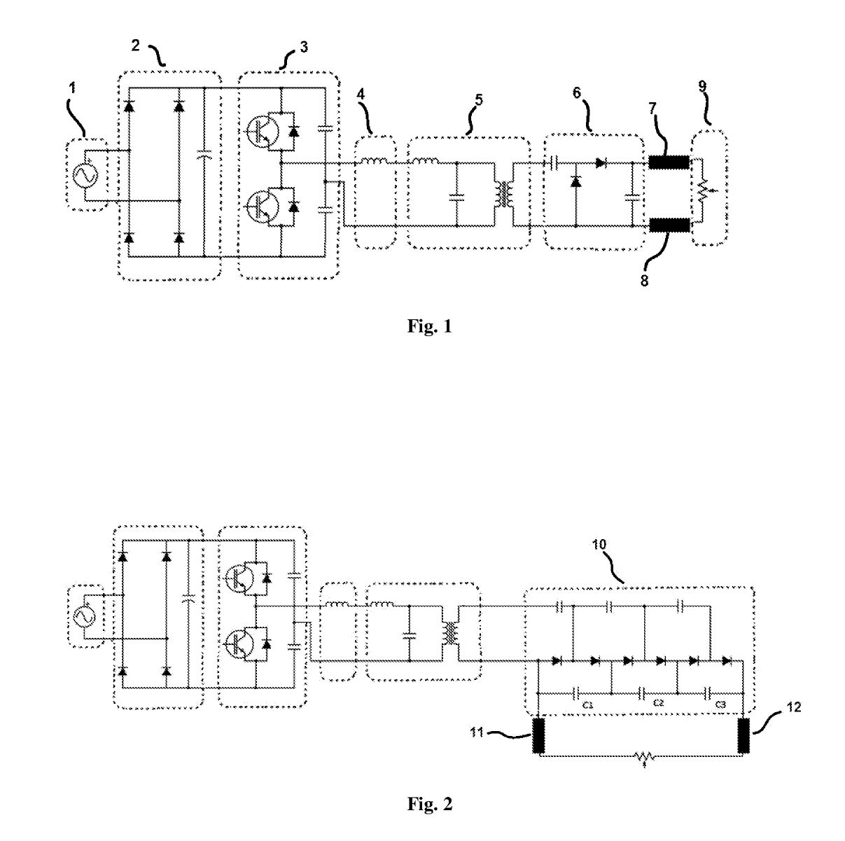

An example of the circuit providing the current for the weeding device is shown in FIG. 1.

The example topology as shown in FIG. 1 can be improved by using a high order voltage multiplier at the transformer's secondary, as a voltage hexuplicator, as shown in FIG. 2. A high order multiplicator simplifies even more the transformer's construction, using the same justifications as before. The impedance matching happens in the same way as described by the converter with the voltage doubler, but in the topology presented below the power coupling range can be extended.

The external inductor reflected to the transformer's secondary side will also provide an impedance matching with the voltage doubler series impedance, and this association with the “plant resistance” will be seen by the transformer as a resistance in parallel with a capacitor inversely proportional to this resistance value. The output voltage will be variable with the resistive load, once the voltage doubler capacitor charging will be “controlled” by the total series impedance seen by him, like that different power values will be delivered by the converter, depending on the resistive load, according to the basic power equation P=V²/R, where R, V and P are the resistive load, its voltage and its power dissipation, respectively. As the impedance matching happens in self-adjustable way, this converter topology presents a self-adjustable power control without the necessity of a control strategy implementation.

The impedance seen by the transformer is still a resistance in parallel with a variable capacitor, as described before. The inverter's resonance switching can be tuned so the converter delivers the optimum maximum power to a specific impedance value. The output power is variable for the same reason as described for the voltage doubler, but for different orders voltage multipliers, all the multipliers capacitors charging must be taken in consideration.

The voltage multiplier series impedance partially solves the problem of transformer series resonance excitation, once the transformer's secondary is never in a real open circuit situation with this new topology.

When the resistive load tends to a low value (short-circuit situation), the voltage multiplier presents a series impedance reflected to the primary that, associated with the external inductor, protects the transformer against high short-circuit currents. When the load tends to a high value (open circuit situation), all the capacitors of the voltage multiplier are charged, increasing the secondary voltage peak, but still limiting it to a maximum value equals the multiplier stage (6, in the case of the hexuplicator).

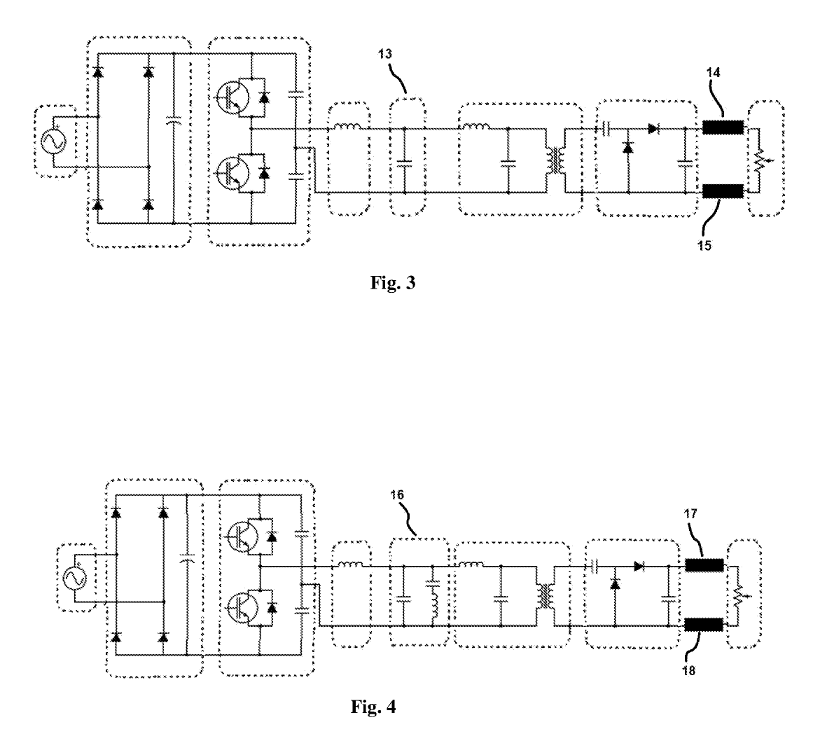

Another strategy to protect the transformer against this dangerous operation is the addition of an adequate capacitive or a capacitive inductive filter after the external inductor, as shown in FIG. 3 and FIG. 4. As the filters can be projected to remove the high order harmonic components from the transformer's input voltage, the series resonance excitation can be avoided with this strategy.

As the “plant resistance” deviates from the tuned value, the delivered power decreases from its optimum maximum value, but a considerable range of power values is still delivered to a great variety of resistive loads, as can be seen in Table below, that show the power delivered to different values of resistive loads, considering power grid as power supply and a capacitive voltage hexuplicator. It's important to notice that the electronic converter as described was never used before for the invasive plant control.

Power Variation with the Resistive Load (2.77 a 100 kΩ)

| | | |
|---|---|---|
| Power Grid | 220 V | 127 V |

| Voltage Value | Current | Active | Current | Active |
|---|---|---|---|---|
| Resistive Load | RMS | Power | RMS | Power |
| (kΩ) | (A) | (W) | (A) | (W) |
| 100 | 1.25 | 270 | 1.3 | 165.1 |
| 75 | 1.55 | 334.8 | 1.64 | 208.28 |
| 50 | 2.2 | 475.2 | 2.29 | 290.83 |
| 25 | 3.05 | 658.8 | 3.33 | 422.91 |
| 12.5 | 2.23 | 481.68 | 2.55 | 323.85 |
| 8.5 | 1.75 | 378 | 2.04 | 259.08 |
| 6.25 | 1.47 | 317.52 | 1.7 | 215.9 |
| 5 | 1.09 | 235.44 | 1.46 | 185.42 |
| 3.57 | 0.929 | 200.664 | 1.18 | 149.86 |
| 2.77 | 0.838 | 181.008 | 1 | 127 |

The electronic converter as described before is optimized for monophasic low and medium power applications, so it's ideal for manual applications, nevertheless the topology can be adapted for high power applications, using high power sources, as DC or tri-phasic sources, and tri-phasic rectifiers, as already described in the other topologies.

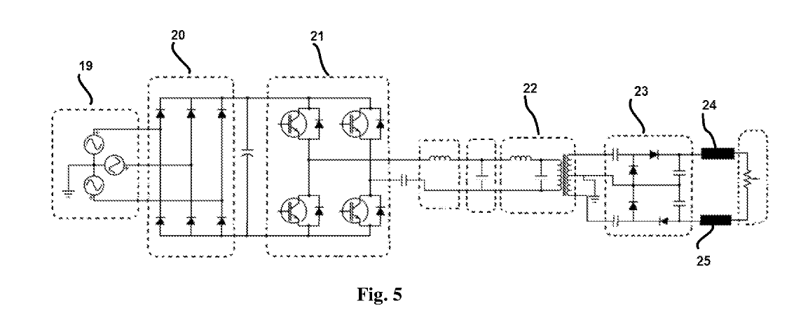

In this case maybe a full-bridge inverter can be more adequate to deliver power levels necessary. Another modification that can be interesting for high power applications is the used of high frequency transformer with a centered tap at its secondary winding, as shown in FIG. 5. The centered tap “divides” the secondary isolation issues and increases the transformer safety. The voltage multiplier can still be used, but now in a duplicated way, as shown in FIG. 5.

As a general description of the system, a DC or AC power supply of any number of phases generates a voltage. This voltage is fed to an inverter that increases frequency. The current with increased frequency is fed to a harmonic filter (inductive, capacitive or both) that ensures a high power-factor, diminishing or excluding the need of a separated PFC. The inductive and/or capacitive harmonic filter may feed a high frequency transformer that further increases the voltage input for the voltage multiplier. The high frequency transformer may comprise a centered tap at its secondary winding, which can serve as a voltage reference or grounding to the secondary coil. The output of the previous components is fed to a voltage multiplier, such as a voltage multiplier of the Cockroft-Walton type or a full wave Cockroft-Walton type, such as a hexuplicator, multiplying the input voltage by a factor of six. The voltage multiplier provides different voltage levels depending on its load, so for a variable load it makes an auto-adjustable power control without any additional circuitry, processor or controller necessity. If, as described, a transformer was necessary to further increase the voltage be-tween the harmonic filter and the voltage multiplier, the voltage multiplier always represents a series impedance connected at the transformer secondary, not letting the transformer in a direct real open circuit situation, reducing the risks of series resonance excitation and voltage peaks that could damage insulation or create other internal damages.

This particular construction allows for the inverter switching to be set as resonant or quasi-resonant. This setting of the inverter as resonant or quasi-resonant, reduces its output harmonic composition, reducing the risk of transformer series resonance excitation and, consequently, reducing the risk of compromise the transformer insulation. Also, the inverter's switches (like, but not limited to IGBTs, power transistors, mosfets) have reduced conduction losses when working in the resonant or quasi-resonant mode, increasing the converter's overall efficiency.

In FIG. 1 the sinusoidal voltage from the power supply 1 is rectified by the full-wave rectifier 2 and produces a pulsed DC voltage which is provided to the half-wave inverter 3. A high-frequency square-wave voltage is then produced by the half-wave inverter 3 and provided to the voltage amplification block (the external inductor 4 and the high-frequency transformer 5). The amplified voltage provided at the output of the high-frequency transformer 5 is duplicated by the voltage doubler 6 and applied at the variable resistive load 9 through the electrodes 7 and 8.

The topology of FIG. 2 works exactly at the same way of FIG. 1, but the voltage at the transformer's output is now multiplied by 6, by the voltage hexuplicator 10. As with FIG. 1, the resistive load receives a higher output voltage through the electrodes 11 and 12. In this topology, a lower voltage ratio transformer can be used, for the same applications when compared to the topology of FIG. 1.

In FIG. 3 the capacitor 13 is added to the topology of FIG. 1, to filter undesired harmonic components at the transformer's input voltage and the high-voltage is delivered to the load through electrodes 14 and 15. In FIG. 4 an inductive-capacitive (LC) filter 16 is used for the same function and the load receives the output voltage through the electrodes 17 and 18.

FIG. 5 shows an adaptation of the topology of FIG. 1 for three-phase systems. The three-phasic full-wave rectifier 20 is fed by the three-phasic power supply 19 and provides its output for the full-wave inverter 21, which works at resonant or quasi-resonant switching, to reduce the inverter's switching losses. The high-frequency transformer 22 now have a centered tap at its secondary side to reduce the secondary voltage stress, once the secondary voltage is normally higher in three-phasic applications. The voltage multiplier 23 is double doubler and is connected in the symmetric way shown in FIG. 5, delivering the high-voltage to the plant resistance through the electrodes 24 and 25.

Although only a few embodiments of the present invention have been shown and described, it is to be understood that many changes and modifications may be made thereunto without departing from the spirit and scope of the invention.

What is claimed is:

1. A weed inactivation device, comprising:
at least two electrodes,
a DC or AC power supply, and
an electro-electronic converter topology configured for supplying current to the at least two electrodes, comprising at least two of the following components:
an inverter,
an inductive and/or capacitive harmonic filter, or
a capacitive voltage multiplier composed of diodes,
wherein the weed inactivation device is constructed alone or in parallel with stages that work together to control invasive plants by electrocution, and wherein at least one of the electrodes is configured to be directed to the weed.

2. The weed inactivation device according to claim 1, further comprising an inverter that is fed by the power supply and is configured to feed the inductive and/or capacitive harmonic filter.

3. The weed inactivation device according to claim 1, further comprising a high frequency transformer that is configured to receive an output of the components.

4. The weed inactivation device according to claim 1, further comprising a voltage multiplier that is configured for receiving an output of the components, the voltage multiplier providing different voltage levels depending on its load.

5. The weed inactivation device according to claim 2, wherein the inverter has switching that is set to be resonant or quasi-resonant.

6. The weed inactivation device according to claim 1, wherein the power supply comprises an AC current supply having a frequency in the range of 30 Hz to 90 Hz, and further comprising a full-wave rectifier that is configured to rectify the AC current, creating pulsed DC current that is double a frequency of the AC current.

7. The weed inactivation device according to the claim 6, further comprising a capacitor that is configured to damp the pulsed DC current, the capacitor being switched parallel to an output of the full-wave rectifier.

8. The weed inactivation device according to the claim 7, further comprising a half-bridge inverter that is configured to switch the pulsed and damped DC current to create a rectangular AC current of higher frequency than the pulsed and damped DC current.

9. The weed inactivation device according to claim 8, further comprising a high frequency transformer that is configured to receive an output of the half-bridge inverter to create a higher voltage than input from the half-bridge inverter.

10. The weed inactivation device according to claim 9, further comprising a cooling sink or cooling blades that are configured for passively cooling the high frequency transformer.

11. The weed inactivation device according to claim 9, wherein the high frequency-transformer comprises a centered tap at a secondary winding.

12. The weed inactivation device according to claim 11, wherein between a first pole of the secondary winding and the centered tap and between a second pole of the secondary winding and the centered tap the pulsed DC current is multiplied by a capacitive voltage multiplier.

13. The weed inactivation device according to claim 12, wherein the voltage multiplier is a hexuplicator that is configured for multiplying the input voltage by a factor of six.
